(19) United States
(12) Patent Application Publication
(10) Pub. No.: US 2026/0037877 A1
(43) Pub. Date: Feb. 5, 2026

(54) EVALUATION AND FINE-TUNING OF GENERATIVE ARTIFICIAL INTELLIGENCE TOOLS

(71) Applicant: Zoom Video Communications, Inc., San Jose, CA (US)

(72) Inventors: Jianbing Han, Los Gatos, CA (US); Ying Lu, Cerritos, CA (US); Kai Ni, Sammamish, WA (US); Jun Tan, Pittsburgh, PA (US); Wang Tian, Hefei (CN); Chao Wang, Hefei (CN); Fan Yang, Hefei (CN)

(73) Assignee: Zoom Video Communications, Inc., San Jose, CA (US)

(21) Appl. No.: 18/789,980

(22) Filed: Jul. 31, 2024

(51) Int. Cl. G06N 20/20

(52) U.S. Cl. CPC G06N 20/20

(57) ABSTRACT

Systems and methods of evaluating and fine-tuning a generative AI tool on a communication platform. The communication platform accesses a dataset comprising a user query and a response generated by an AI-based query system. The communication platform evaluates the response with respect to the user query using multiple AI-based scoring models to obtain multiple evaluation results. In response to determining that the multiple evaluation results are inconsistent, the communication platform evaluates the response with respect to the user query using a reference large language model (LLM) to provide a reference evaluation result. In response to determining that the reference evaluation result is decisive, the communication platform classifies, based on the reference evaluation result, the dataset to a data category of one or more data categories. The communication platform fine-tunes the AI-based query system based on a group of datasets in the data category.

### FIELD

The present application generally relates to artificial intelligence and more specifically relates to evaluation and fine-tuning of generative artificial intelligence (AI) tools.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionality to various client devices;

FIG. 2 shows an example system in which a chat and video conference provider provides chat and videoconferencing functionality to various client devices;

FIG. 3 shows an example system for using LLMs to perform certain generative tasks based on communication data generated on a communication platform;

FIG. 4 shows an example system that is configured for evaluation and fine-tuning of generative AI tools;

FIG. 5 shows an example process for evaluation and fine-tuning of a generative AI tool;

FIG. 6 shows an example computing device suitable for use with example systems and methods for evaluation and fine-tuning of generative AI tools.

### DETAILED DESCRIPTION

Examples are described herein in the context of evaluation and fine-tuning of generative AI tools. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Generative artificial intelligence (AI) tools can provide answers to user queries in different applications. It is crucial to evaluate response qualities in order to improve the performance of the generative AI tools. The response quality includes accuracy, relevance, and effectiveness with respect to a user query. The evaluation results for generated responses can be used for fine-tuning the generative AI tools.

To improve the performance of a generative AI tool, an evaluation system is provided to evaluate responses generated by the generative AI tool. The generative AI tool can be an AI-based query system using a large language model (LLM) to generate responses to user queries. An example evaluation system includes multiple scoring models and a reference model. The example evaluation system accesses user inputs (e.g., user queries) to the generative AI tool and corresponding outputs (e.g., responses) provided by the generative AI tool. The example evaluation system also accesses certain intermediate datasets used for generating the outputs provided by the generative AI tool, for example natural language processing (NLP) analytics data of the user input, relevant datasets identified from available databases for generating the output, rankings of the relevant datasets, etc.

Each of the multiple scoring models of the example evaluation system evaluates an output of a generative AI tool and associated intermediate datasets based on certain evaluation metrics, for example accuracy, recall, precision, F1-score, or rank-aware metrics (e.g., mean reciprocal rank (MRR), mean average precision (MAP), and Normalized Discounted Cumulative Gain (NDCG)). A scoring model includes, uses, or implements a small language model or smaller versions of an LLM. The multiple scoring models rate the output by evaluating the output itself and certain intermediate datasets used for generating the output. The multiple scoring models provide multiple evaluation results respectively. In some examples, evaluation results can be descriptive, such as “good,” “bad,” or “indeterminate.” Alternatively, or additionally, the evaluation results are numerical scores.

If the multiple evaluation results for an output are consistent, the output paired with the user input (or the input-output dataset) is classified into a corresponding category. For example, if all the evaluation results from the multiple scoring models are “good,” the output paired with the user input is classified to a data category named “good datasets” or a name with similar meaning (e.g., positive datasets). If all the evaluation results are “bad,” the output paired with the user input is classified to a data category named “bad datasets.” If the multiple evaluation results are inconsistent, for example some evaluation results are “good” and others are “bad,” the output paired with the user input is provided to the reference model for further evaluation. In another example, the multiple evaluation results are scores. If the multiple scores are all higher than a predetermined threshold, the output paired with the user input is classified to a data category named “good datasets.” If the multiple evaluation scores are all less than the predetermined threshold, the output paired with the user input is classified to a category named “bad datasets.” If some of the multiple evaluation scores are higher than the predetermined threshold and others are less than the predetermined threshold, the output paired with the user input is provided to the reference model for further evaluation.

The reference model includes, uses, or implements a generative pre-trained transformer (GPT) model or its variations, or other suitable LLMs that are generally considered to have a strong overall performance. The reference model evaluates the output and associated intermediate datasets to provide a reference evaluation result. Similar to the evaluation result by a scoring model, the reference evaluation result can be descriptive or numerical. If the reference evaluation result is descriptive and decisive (e.g., “good” or “bad”), the output is classified to a data category based on the reference evaluation result. If the reference evaluation result is indeterminate, the output paired with the user input is provided to a human evaluator to evaluate. The example evaluation system also collects user feedback on a generated output. For example, a user has rated the output of the generative AI tool. If the user feedback is different from the evaluation results from the scoring models or the reference model, the user feedback overrides the evaluation results to update the classification of the corresponding input-output dataset.

The example evaluation system collects and aggregates outputs paired with user inputs based on their categories over time to obtain a set of good datasets and a set of negative datasets. Each dataset includes an output paired with the corresponding user input and labeled with a corresponding classification (e.g., “good dataset” or “bad dataset”). The good datasets and bad datasets are provided to fine-tune the generative AI model used or implemented in the generative AI tool. In addition, the good datasets and bad datasets are also used to retrain or validate the scoring models.

Thus, an evaluation system integrated with a generative AI tool evaluates and facilitates improving the performance of the generative AI tool. Meanwhile, the evaluation system improves itself by retraining certain language models used in the evaluation system based on evaluation results of generated outputs paired with user inputs from the generative AI tool.

This illustrative example is given to introduce the reader to the general subject matter discussed herein and the disclosure is not limited to this example. The following sections describe various additional non-limiting examples and examples of evaluation and fine-tuning of generative artificial intelligence (AI) tools.

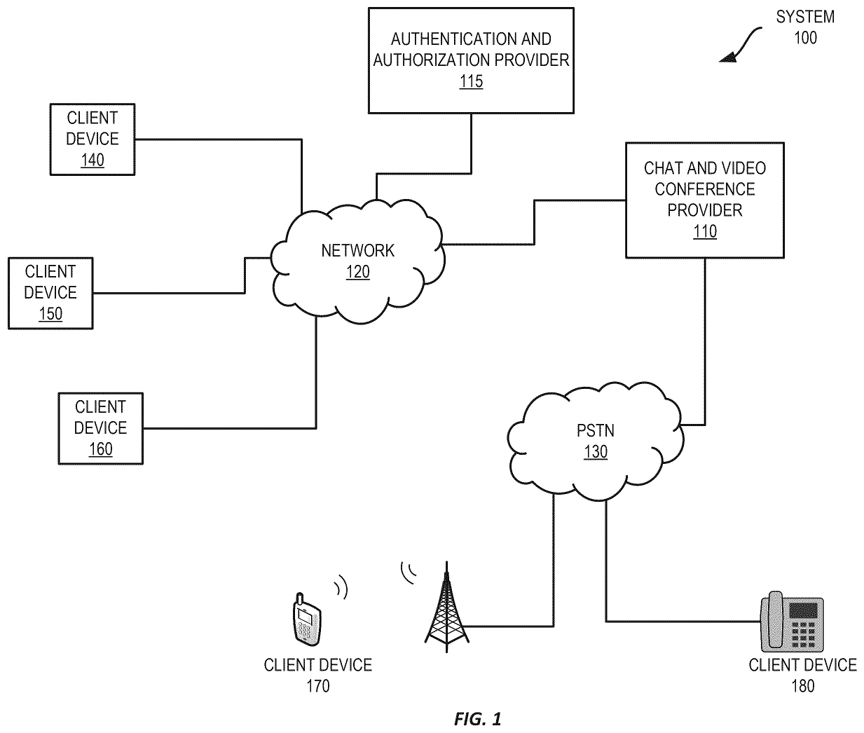

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

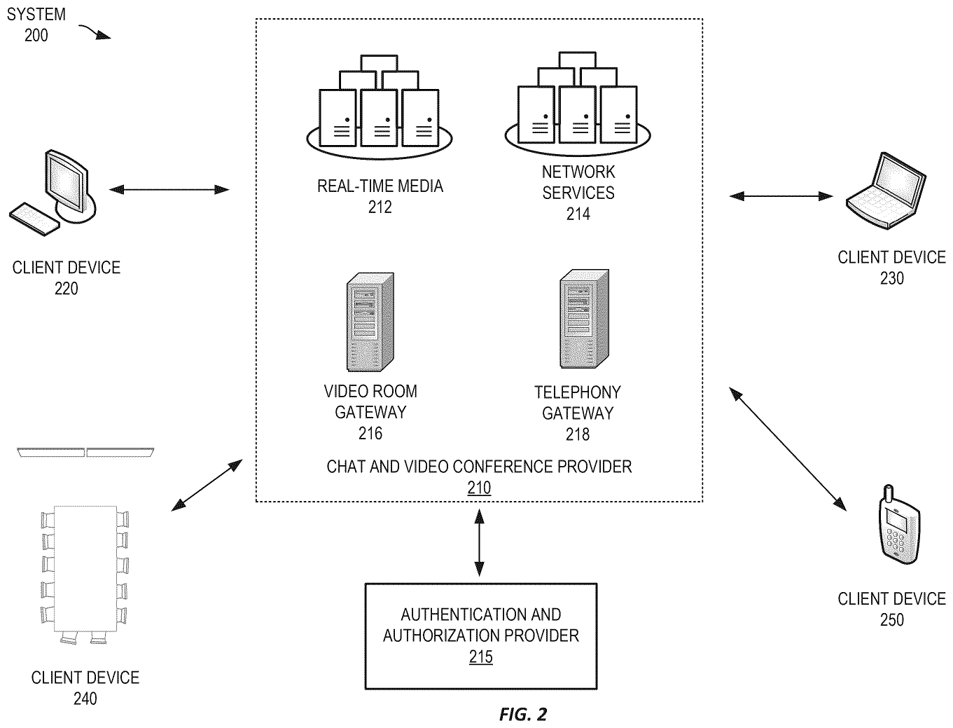

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

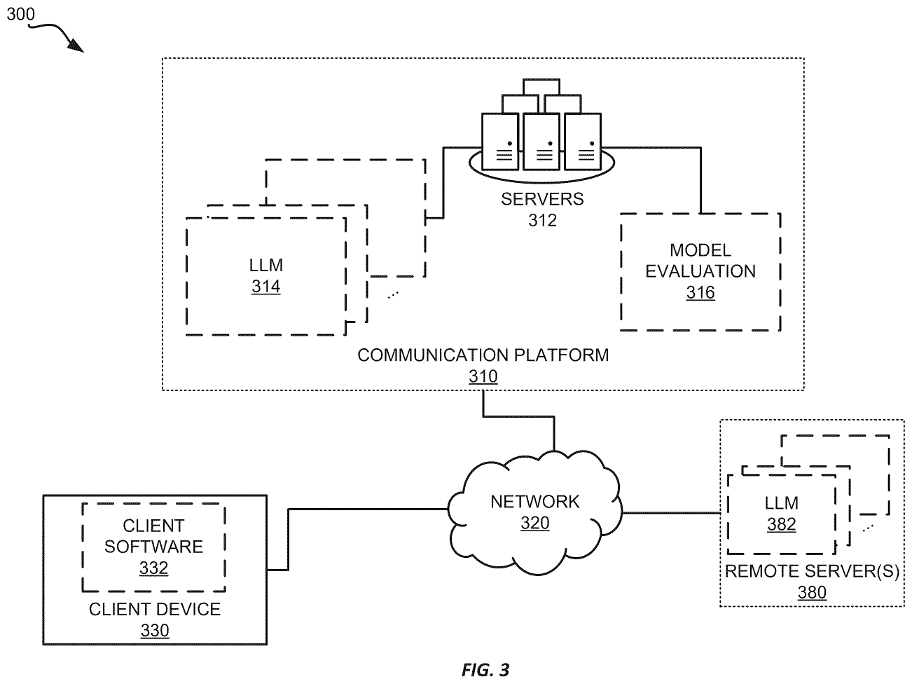

Referring now to FIG. 3, FIG. 3 shows an example system 300 for using LLMs to perform certain generative tasks based on communication data generated on a communication platform. In this example, the system 300 includes a client device 330, a communication platform 310, and one or more remote servers 380 that host one or more LLMs 382 in network communication with network 320. In this example, the communication platform 310 provides chat and virtual conferencing capabilities, such as discussed above with respect to FIGS. 1-2, but also provides one or more servers 312 that provide one or more LLMs 314 that may be used to service requests received from users via their respective client device, such as client device 330. The LLM 314 may be a model that has been trained on a large corpus of data, such as information available from licensed, commercially usable, non-public datasets. For LLMs, the training data may be written materials, such as webpages, documents, emails, or blogs that may be relevant to generating written works.

Client devices may execute client software 332 to join and participate in virtual conferences hosted by the communication platform 310. During a virtual conference, the participants can exchange audio and video streams, as discussed above with respect to FIGS. 1-2, to interact with each other, discuss any topics of interest, and share content. Similarly, the participants can continue any discussions outside of a virtual conference, such as by using chat functionality provided by the communication platform 310. They may also email each other using email services provided by the communication platform 310 or another third party.

A user may enter a user query, via a client device 330, for searching certain data on the communication platform 310. The user query can be provided to a trained machine learning (“ML”) model, such as an LLM. The trained LLM can generate a response to the user query. In addition, the communication platform 310 provides evaluation functionality 316 to evaluate capabilities of LLMs and provide corresponding feedback for fine-tuning.

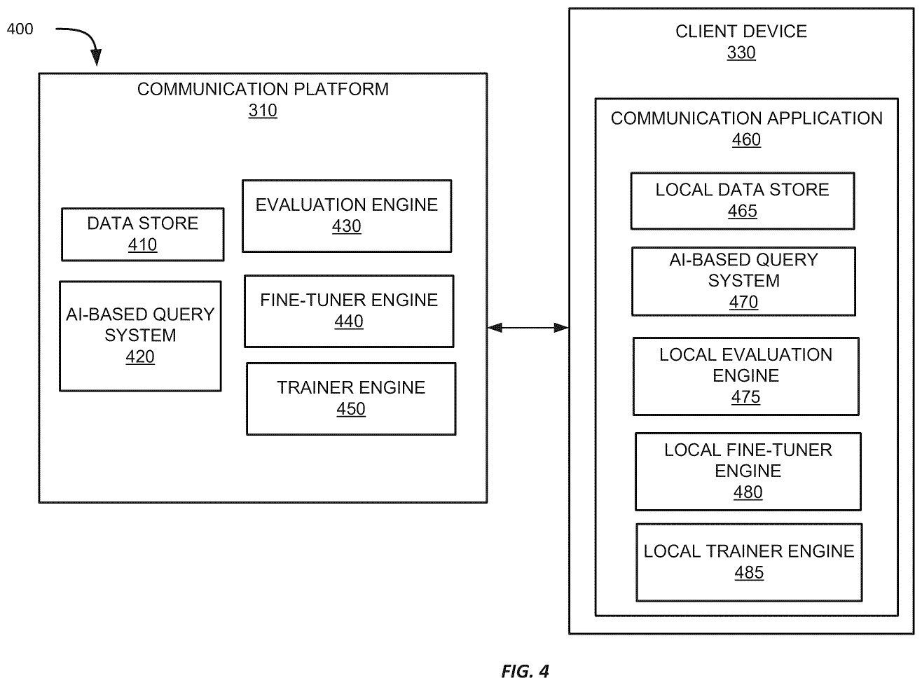

Referring now to FIG. 4, FIG. 4 shows an example system that is configured for evaluation and fine-tuning of generative AI tools. The communication platform 310 is in network communication with a client device 330. The communication platform 310 includes a data store 410, an AI-based query system 420, an evaluation engine 430, a fine-tuner engine 440, and a trainer engine 450. The data store 410 stores historical communication data associated with different client devices 330, among other types of data. The historical communication data include video conference recordings, video conference transcripts, chat messages, emails, and other suitable types of communication data. The data store 410 also stores user queries and corresponding responses provided by the AI-based query system 420. The data store 410 also stores data categories classifying the responses paired with corresponding user queries based on evaluation results. The data store 410 also stores intermediate datasets that were generated by the AI-based query system 420 for generating a response to a user query. Examples of intermediate datasets include NLP analytics data of a user query, search results (e.g., communication data identified to be relevant for response generation), score rankings of the search results, and semantic analytics of a generated response.

The AI-based query system 420 is configured to generate a response to a user query, for example based on historical communication data. The AI-based query system 420 uses or implements an NLP algorithm to interpret the user query, for example to determine keywords, synonyms, or topics, which constitutes NLP analytics data associated with the user query as part of the intermediate datasets. The AI-based query system 420 uses or implements certain information retrieval techniques (e.g., text matching, embedding matching, etc.) to identify and retrieve relevant communication data associated with the user query, based on the NLP analytics data. The AI-based query system 420 evaluates or ranks the identified relevant communication data to generate rankings of the identified relevant communication data for response generation. The AI-based query system 420 uses or implements a generative AI model to generate a response based on the rankings of the identified relevant communication data. In some examples, the AI-based query system 420 analyzes the generated response to obtain semantic analytics data, which can be used to further refine the generated response.

The evaluation engine 430 is configured to evaluation responses generated by the AI-based query system 420. The evaluation engine 430 accesses user queries and corresponding responses generated by the AI-based query system 420. The evaluation engine 430 also accesses certain intermediate datasets, such as NLP analytics data of a user input, score ranking data of identified communication data relevant to the user query, and semantic analytics data of a generated response, which are generated by the AI-based query system 420 during the process of generating a response to a user query.

The evaluation engine 430 includes multiple scoring models and a reference model. Each of the multiple scoring models of the evaluation engine 430 evaluates the response generated by the AI-based query system 420 based on certain evaluation metrics to provide an evaluation result. The evaluation metrics include an accuracy metric, a recall metric, a precision metric, or an F1-score. Accuracy refers to whether the response is factually accurate. For example, the user query is “which continent does the United States belong to?” The generated response is “United States is on the continent of Africa.” The response is grammatically correct, but factually wrong. The scoring module can use the accuracy metric to indicate if or how much the response is factually accurate. The recall metric measures how much relevant instances were retrieved from all relevant instances. The precision metric measures how much relevant retrieved instances compared to all the retrieved instances. The recall metric and the precision metric are evaluation metrics related to search results for generating the response. The F1-score is the harmonic mean of the precision metric and the recall metric.

In addition, the evaluation metrics also includes rank-aware evaluation metrics, such as mean reciprocal rank (MRR), mean average precision (MAP), and Normalized Discounted Cumulative Gain (NDCG). The rank-aware evaluation metrics measures the rankings of communication data identified as relevant to a user query for response generation. The accuracy of the ranking affects the accuracy of the response. The MRR metric quantifies the rank of the first relevant instance in a ranking of relevant instances by taking the reciprocal of the rank of the first relevant instance. For example, if the first relevant instance is ranked second in a ranking, the MRR for the first relevant instance is the reciprocal of 2, which is ½ or 0.5. The MAP metric is the mean of average precision metric values for each query. The NDCG metric is a ranking quality metric, comparing rankings to an ideal order where all relevant items are at the top of the ranking. The NDCG measures the total item relevancy in a ranking, with a value from 0 to 1, with 1 indicating a match with the ideal order, and lower values representing a lower quality of ranking.

A scoring model includes, uses, or implements a small language model or smaller versions (or lite versions) of corresponding large language model (LLMs) trained to provide an evaluation result. Examples of the small language models or smaller versions of an LLM include XLM-Roberta, Prometheus, MiniLM, ROBERTA, ALBERT-XXL. The multiple scoring models rate the response by evaluating the response itself and certain intermediate datasets used for generating the response. The multiple scoring models provide multiple evaluation results respectively for a response.

In some examples, the evaluation results are descriptive, such as “good,” “bad,” or “indeterminate.” If the multiple evaluation results for a response are consistent, evaluation engine 430 classifies the response paired with the user query into a corresponding data category. For example, if all the evaluation results from the multiple scoring models are “good,” the response paired with the user query is classified into a data category named “good datasets.” In some examples, the response paired with the user query (the query-response dataset) is labeled as “a good dataset.” In some examples, the response is labeled as “good” indicating it is a good response to the user query. Similarly, if all the evaluation results are “bad,” the evaluation engine 430 classifies the response paired with the user query into a data category named “bad datasets.” The query-response dataset can also be labeled as “a bad dataset.” Alternatively, or additionally, the response is labeled as “bad” indicating it is a bad response to the user query. If the multiple evaluation results are inconsistent or all of the multiple evaluation results are “indeterminate”, the evaluation engine 430 uses or implements a reference model to further evaluate the response paired with the user query.

Alternatively, the multiple evaluation results are scores, for example in a range between 0 and 10. In some examples, there is a predetermined threshold for a “good” or “bad” classification of the query-response datasets. If the multiple scores are all higher than a predetermined threshold (e.g., 6), the response paired with the user input is classified into a data category named “good datasets,” the response paired with the user query (the query-response dataset) is labeled as “a good dataset,” or the response is labeled as “good” indicating it is a good response. If the multiple evaluation scores are all less than the predetermined threshold, the response paired with the user query is classified into a data category named “bad datasets,” the response paired with the user query is labeled as “a bad dataset,” or the response is labeled as “bad” indicating it is a bad response. If some of the multiple evaluation scores are higher than the predetermined threshold and others are less than the predetermined threshold, the multiple evaluation results are inconsistent, and the response paired with the user query is provided to the reference model for further evaluation.

In some examples, there are two threshold values for a “good,” “indeterminate,” or “bad” classification of the query-response datasets. If all of the multiple evaluation results are greater than a first predetermined threshold (e.g., 7 (for scores ranging between 0 and 10) representing a threshold to be a good response), the multiple evaluation results are considered as consistent, and the query-response dataset is classified as a “good” dataset. If all of the multiple evaluation results are less than a second predetermined threshold (e.g., 5 representing a threshold to be a bad response), the multiple evaluation results are considered as consistent, and the query-response dataset is classified as a “bad” dataset. If some of the multiple evaluation results are greater than the first threshold value and the others are less than the first threshold value, the multiple evaluation results may be considered as inconsistent. If some of the multiple evaluation results are less than the second threshold value and the others are greater than the second threshold value, the multiple evaluation results may be classified as inconsistent.

In some examples, there are more than two data categories (e.g., “good datasets” and “bad datasets”) corresponding to different response qualities. For example, there are “best datasets,” “good datasets,” “average datasets,” and “bad datasets.” Correspondingly, there are different threshold values for the multiple data categories (or response qualities). For example, if all the evaluation scores (in a range between 0 and 10) are greater than 8, the query-response dataset is classified as a “best” dataset. If the lowest evaluation score of the multiple scores (in a range between 0 and 10) is greater than 7, the query-response dataset is classified as a “good” dataset. If the lowest evaluation score of the multiple scores (in a range between 0 and 10) is greater than 6, the query-response dataset is classified as a “good” dataset. If all the evaluation scores (in a range between 0 and 10) are between 7 and 8, the query-response dataset is classified as a “good” dataset. If all the evaluation scores (in a range between 0 and 10) are greater than 8, the query-response dataset is classified as an “average” dataset.

The reference model includes, uses, or implements a GPT model, a Mistral model, a Falcon model, or other suitable LLMs and variants that are generally considered to have a strong overall performance. The reference model evaluates the response to provide a reference evaluation result. Similar to the evaluation result by a scoring model, the reference evaluation result can be descriptive or numeric. If the reference evaluation result is descriptive and decisive (e.g., “good” or “bad”), the query-response dataset is classified based on the reference evaluation result. If the reference evaluation result is indeterminate, the response paired with the user query is provided to a human evaluator to evaluate. If the reference evaluation result is numeric and satisfies certain threshold for a corresponding data category, the query-response dataset can be classified to the corresponding dataset. The thresholds used at the reference model can be the same as or similar to the thresholds used at the multiple scoring models. For example, if the reference score is 8.5, greater than a threshold of 6 for the “good datasets” category, the query-response dataset is classified into the “good datasets” category.

The evaluation engine 430 also collects user feedback on a generated response. For example, a user has rated the response provided by the AI-based query system 420. If the user feedback is different from the evaluation results from the scoring models or the reference model, the user feedback overrides the evaluation results for the classification of the corresponding response paired with the user query.

The evaluation engine 430 collects and aggregates responses paired with user queries based on their corresponding evaluation results over time to obtain a set of good datasets and a set of bad datasets. The good datasets and the bad datasets can be used as positive training data and negative training data for fine-tuning the AI-based query system 420 or retraining the AI models in the evaluation engines.

The fine-tuner engine 440 is configured to fine-tune the generative AI model used or implemented by the AI-based query system 420 based on a subset of good datasets and/or a subset of bad datasets. The fine-tuner engine 440 includes an AI/ML model provided by the communication platform 310 or by the remote server 380 and trained to fine-tune the generative AI model in the AI-based query system 420. In some examples, the fine-tuner engine 440 uses one or more good datasets to fine-tune the generative AI model in the AI-based query system 420. A good dataset includes a reference user query and a positive reference response. The fine-tuner engine 440 provides the reference user query to the AI-based query system 420 and obtains a target response. The fine-tuner engine 440 then minimizes a loss function (e.g., cross-entropy loss) associated with the target response and the positive reference response, by adjusting or optimizing certain weights in the generative AI model of the AI-based query system 420. Similarly, the fine-tuner engine 440 uses one or more bad datasets to fine-tune the generative AI model in the AI-based query system 420. A bad dataset includes a reference user query and a negative reference response. The fine-tuner engine 440 provides the reference user query to the AI-based query system 420 and obtains a target response from the generative AI model. The fine-tuner engine 440 then maximize a loss function associated with the target response and the negative reference response, by adjusting or optimizing certain weights in the generative AI model of the AI-based query system 420. The fine-tuner engine 440 then updates a subset of model parameters of the generative AI model of the AI-based query system 420.

The trainer engine 450 is configured to retrain one or more scoring models implemented by the evaluation engine 430. The trainer engine 450 is similar to the fine-tuner engine 440, generally as described above. However, since the scoring models in the evaluation engine 430 are smaller AI models, with less parameters than the regular LLMs, the trainer engine 450 can retrain the scoring models. The trainer engine 450 uses a group of good datasets and/or a group of bad datasets to optimize weight parameters used in the scoring models. In some examples, the trainer engine 450 or another engine on the communication platform 310 validates a scoring model based on a group of good datasets and/or a group of bad datasets. For example, the trainer engine 450 provides a group of good datasets to a scoring model, which generates evaluation results for the group of good datasets. If most (e.g., a threshold number or percentage such as 60%) of the evaluation results are “bad” or “indeterminate,” the trained engine 450 replaces the scoring model with another model, which performs better.

The client device 330 is installed with a communication application 460 provided by the communication platform 310. In some examples, the communication application 460 installed on the client device 330 include a local data store 465, a local AI-based query system 470, a local evaluation engine 475, a local fine-tuner engine 480, and a local trainer engine 485. The local data store 465 stores communication data associated with communication sessions hosted or joined by a local user associated with the client device 330, user queries by the local user and corresponding responses generated by the local AI-based query system 470, local intermediate datasets related to response generation, and other suitable data. The local AI-based query system 470 is configured to generate responses to user queries, similar to the AI-based query system 420 on the communication platform 310. The local evaluation engine 475 is configured to evaluate the performance of the local AI-based query system 470, similar to the evaluation engine 430 on the communication platform 310. The local fine-tuner engine 480 is configured to fine-tune a generative AI model used in the local AI-based query system 470, similar to the fine-tuner engine 440 on the communication platform 310. The local trainer engine 485 is configured to retrain scoring models in the local evaluation engine 475, similar to the trainer engine 450 on the communication platform.

The communication application 460 also includes a graphical user interface (GUI) for receiving user queries and displaying responses to user queries. In some examples, the GUI includes a search box for a user to enter a user query. In some examples, the GUI includes a chat box for a user to interact with a chat bot representing the AI-based query system 420 or the local AI-based query system 470. The user can provide user feedback on the response, for example by pressing or clicking a thumbs up or thumbs down button in the GUI.

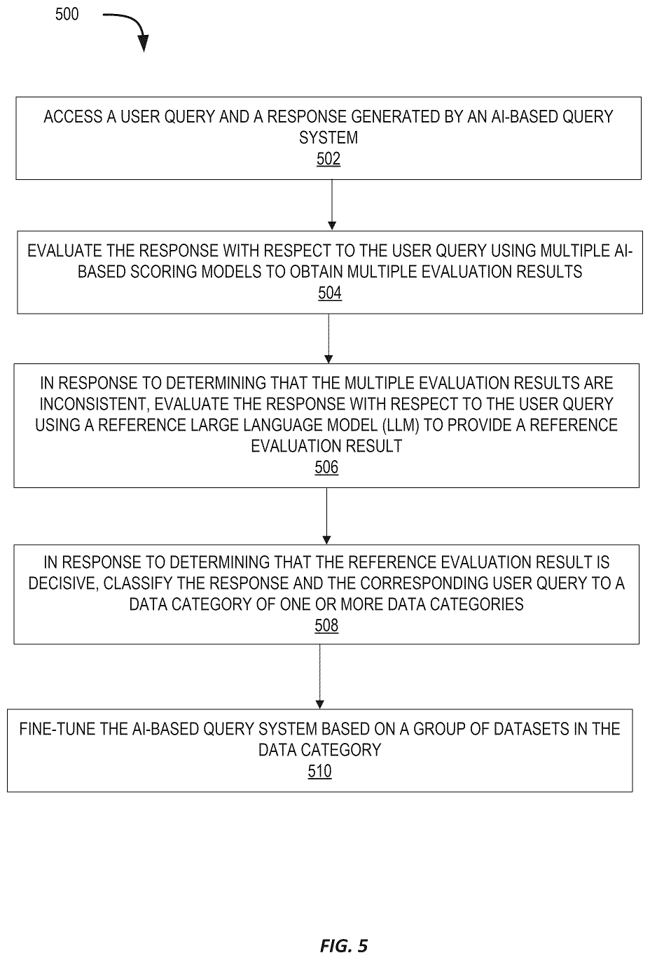

Referring now to FIG. 5, FIG. 5 shows an example process 500 for evaluation and fine-tuning of a generative AI tool. The example process 500 will be discussed with respect to the system 400 shown in FIG. 4; however, any suitable system for evaluation and fine-tuning of a generative AI tool may be used.

At block 502, a communication platform 310 accesses a dataset comprising a user query and a response generated by an AI-based query system 420. An evaluation engine 430 on the communication platform 310 accesses a data store 410 to retrieve a dataset including a user query and a response generated by the AI-based query system 420 on the communication platform 310. In some examples, the evaluation engine 430 also retrieves intermediate datasets associated by the query-response dataset. The intermediate datasets include NLP analytics data of the user query, score ranking of communication data relevant to the user query, and semantic analytics data of the response.

At block 504, the communication platform 310 evaluates the response with respect to the user query using multiple AI-based scoring models to obtain multiple evaluation results. The evaluation engine 430 on the communication platform 310 uses or implements multiple (e.g., 3 or more than 3) AI-based scoring models to evaluate the response with respect to the user query. Each AI-based scoring model evaluates the response generated by the AI-based query system 420 based on certain evaluation metrics, for example accuracy, recall, precision, F1-score, MRR, MAP, or NDCG, to provide an evaluation result, generally as described in FIG. 4. An AI-based scoring model uses or implements a small language model or smaller versions (or lite versions) of a regular LLM trained for evaluation. The evaluation result can be a comparative value for the response. The evaluation result can be descriptive, for example “good,” “bad,” or “indeterminate.” Alternatively, or additionally, the evaluation result is a score, for example a number between 0 and 10.

At block 506, the communication platform 310, in response to determining that the multiple evaluation results are inconsistent, evaluates the response with respect to the user query using a reference large language model (LLM) to provide a reference evaluation result. The evaluation engine 430 compares the multiple evaluation results to determine if they are consistent or not. In some examples, the evaluation results are descriptive. If all of the multiple evaluation results are “good” or “bad,” the multiple evaluation results are consistent. If one of the multiple evaluation results are different from the others, the multiple evaluation results may be inconsistent in some examples. In some examples, a threshold number of inconsistent results may be established, e.g., if greater than 10% of the results are inconsistent, the evaluations may be determined to be inconsistent. In some examples, the evaluation results are scores. If all of the multiple evaluation results are greater than a first predetermined threshold (e.g., representing a threshold to be a good response), the multiple evaluation results are classified as consistent. If all of the multiple evaluation results are less than a second predetermined threshold (e.g., representing a threshold to be a good response), the multiple evaluation results are considered as consistent. If some of the multiple evaluation results are greater than the first threshold value and the others are less than the first threshold value, the multiple evaluation results may be considered as inconsistent. If some of the multiple evaluation results are less than the second threshold value and the others are greater than the second threshold value, the multiple evaluation results may be considered as inconsistent. However, as noted above, a threshold may be used in some examples to determine whether different results cause the set of evaluation results to be inconsistent. If the multiple evaluation results are consistent, the evaluation engine 430 classifies the dataset to a data category based on the multiple evaluation results. If the multiple evaluation results are inconsistent, the evaluation engine 430 uses or implements a reference model to evaluate the dataset to obtain a reference evaluation result. The reference model can be a GPT model or another LLM which is considered to have strong performance.

At block 508, the communication platform 310, in response to determining that the reference evaluation result is decisive, classifies, based on the reference evaluation result, the dataset to a data category of one or more data categories. Similar to the multiple evaluation results generated by the multiple AI-based scoring models, the reference evaluation result can be descriptive (e.g., good, bad, or indeterminate) or numerical (e.g., a number between 0 and 10). If the reference evaluation result is “good” or “bad,” it is decisive, and the evaluation engine classifies the dataset to a data category based on the reference evaluation result. For example, if the reference evaluation result is “good,” the dataset is classified into a data category named “good datasets.” If the reference evaluation result is “bad,” the dataset is classified into a data category named “bad datasets.” If the reference evaluation result is “indeterminate” or a similar description, it is indeterminate, and the evaluation engine 430 provides the dataset to a human evaluator for evaluation.

Also as an example, if the reference evaluation result is greater than the first threshold value (e.g., a threshold to be considered as a good response), the reference evaluation result is decisive, and the evaluation engine 430 classifies the dataset to a data category named “positive datasets.” If the reference evaluation result is less than the second threshold value (e.g., a threshold to be considered as a bad response), where the second threshold value is less than the first threshold value, the reference evaluation result is decisive, and the evaluation engine 430 classifies the dataset to a data category named “bad datasets.” If the reference evaluation result is less than the first threshold value and greater than the second threshold value, the reference evaluation result is indeterminate, the evaluation engine 430 provides the dataset to a human evaluator for evaluation.

At block 510, the communication platform 310 fine-tunes the AI-based query system based on a group of datasets in the data category. The fine-tuner engine 440 on the communication platform 310 can fine-tune the AI-based query system 420 based on datasets from the one or more data categories, generally as described in FIG. 4. For example, the fine-tuner engine 440 retrieves a dataset from the “good datasets” category as a reference dataset, including a reference user query and a positive reference response. The fine-tuner engine 440 provides the reference user query to the AI-based query system 420 to obtain a target response generated by the AI-based query system 420. The fine-tuner engine 440 minimizes a loss function associated with the target response and the positive reference response to optimize certain weights of the generative AI model in the AI-based query system 420.

In some examples, the trainer engine 450 retrains one or more of the multiple AI-based scoring models. Similar to the fine-tuning, the trainer engine 450 retrieves a dataset from the “good datasets” category as a reference dataset, including a reference user query and a positive reference response. The trainer engine 450 provides the reference dataset to an AI-based scoring model to obtain a target evaluation result generated by the AI-based scoring model. The trainer engine 450 minimizes a loss function associated with the target evaluation result and the positive evaluation result to optimize the weights of the AI-based scoring model. Since the AI-based scoring models are smaller LLMs, having less weight parameters, it can be retrained to update all the weigh parameters.

The example process 500 illustrates a method for evaluation and fine-tuning of a generative AI tool. However, not every step in the example process 500 may be needed, some other steps may be added, or the order of the steps may be changed. Alternatively, the example process 500 can be performed by a communication application 460 installed on a client device 330.

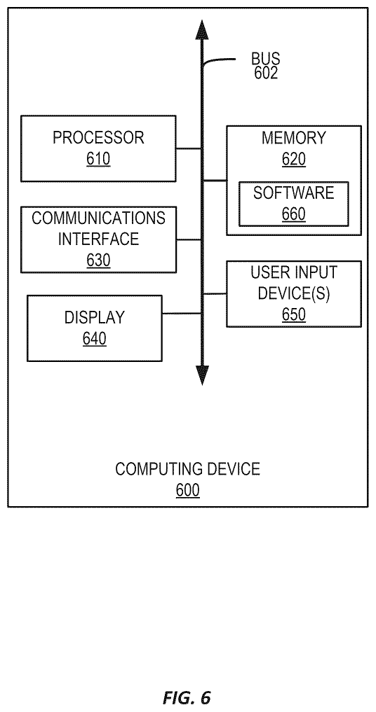

Referring now to FIG. 6, FIG. 6 shows an example computing device 600 suitable for use in example systems or methods for evaluation and fine-tuning of generative AI tools. The example computing device 600 includes a processor 610 which is in communication with the memory 620 and other components of the computing device 600 using one or more communications buses 602. The processor 610 is configured to execute processor-executable instructions stored in the memory 620 to perform one or more methods for resource management according to different examples, such as part or all of the example process 500 described above with respect to FIG. 5. In some embodiments, the computing device may include software 660 for executing one or more methods described herein, such as for example, one or more steps of process 500. The computing device 600, in this example, also includes one or more user input devices 650, such as a keyboard, mouse, touchscreen, microphone, etc., to accept user input. The computing device 600 also includes a display 640 to provide visual output to a user.

The computing device 600 also includes a communications interface 630. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing a dataset comprising a user query and a response generated by an artificial intelligence (AI)-based query system;
evaluating the response with respect to the user query using multiple AI-based scoring models to obtain multiple evaluation results;
in response to determining that the multiple evaluation results are inconsistent, evaluating the response with respect to the user query using a reference large language model (LLM) to provide a reference evaluation result;
in response to determining that the reference evaluation result is decisive, classifying, based on the reference evaluation result, the dataset to a data category of one or more data categories; and
fine-tuning the AI-based query system based on a group of datasets in the data category.

2. The method of claim 1, wherein the multiple AI-based scoring models comprises small language models or a lite version of an LLM.

3. The method of claim 1, wherein the reference LLM comprises a generative pre-trained transform (GPT) model.

4. The method of claim 1, further comprises:
accessing multiple intermediate datasets generated by the AI-based query system during a process of generating the response with respect to the user query, the multiple intermediate datasets comprising analytics data of the user query, multiple search results, a ranking of the search results for response generation, and semantic analytics data of the response; and
evaluating the response by evaluating the multiple intermediate datasets using the multiple AI-based scoring models to obtain multiple evaluation results.

5. The method of claim 1, further comprising:
in response to determining that the multiple evaluation results are consistent, classifying the response and the corresponding user query based on the multiple evaluation results.

6. The method of claim 1, further comprising:
in response to determining that the reference evaluation result is indeterminate, providing the response and the corresponding user query to a human evaluator for manual evaluation.

7. The method of claim 1, wherein the reference evaluation result comprises a description or a score.

8. The method of claim 1, wherein the one or more data categories comprise a “positive datasets” category and a “negative datasets” category.

9. The method of claim 1, further comprising:
retraining one or more of the multiple AI-based scoring models by using the group of datasets in the data category.

10. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access a dataset comprising a user query and a response generated by an artificial intelligence (AI)-based query system;
evaluate the response with respect to the user query using multiple AI-based scoring models to obtain multiple evaluation results;
in response to determining that the multiple evaluation results are inconsistent, evaluate the response with respect to the user query using a reference large language model (LLM) to provide a reference evaluation result;
in response to determining that the reference evaluation result is decisive, classify, based on the reference evaluation result, the dataset to a data category of one or more data categories; and
fine-tune the AI-based query system based on a group of datasets in the data category.

11. The system of claim 10, wherein the multiple AI-based scoring models comprises small language models or a lite version of an LLM, wherein the reference LLM comprises a generative pre-trained transform (GPT) model.

12. The system of claim 10, wherein the one or more processors are configured to execute further processor-executable instructions stored in the non-transitory computer-readable medium to:
accesses multiple intermediate datasets generated by the AI-based query system during a process of generating the response with respect to the user query, the multiple intermediate datasets comprising analytics data of the user query, multiple search results, a ranking of the search results for response generation, and semantic analytics data of the response; and
evaluate the response by evaluating the multiple intermediate datasets using the multiple AI-based scoring models to obtain the multiple evaluation results.

13. The system of claim 10, wherein the one or more processors are configured to execute further processor-executable instructions stored in the non-transitory computer-readable medium to:
in response to determining that the multiple evaluation results are consistent, classify the response and the corresponding user query based on the multiple evaluation results.

14. The system of claim 10, wherein the one or more processors are configured to execute further processor-executable instructions stored in the non-transitory computer-readable medium to:
in response to determining that the reference evaluation result is indeterminate, provide the response and the corresponding user query to a human evaluator for manual evaluation.

15. The system of claim 10, wherein the reference evaluation result comprises a description or a score, and wherein the one or more data categories comprise a “positive datasets” category and a “negative datasets” category.

16. The system of claim 10, wherein the one or more processors are configured to execute further processor-executable instructions stored in the non-transitory computer-readable medium to:
retrain one or more of the multiple AI-based scoring models by using the group of datasets in the data category.

17. A non-transitory computer-readable medium comprising processor-executable instructions configured to cause one or more processors to:
access a dataset comprising a user query and a response generated by an artificial intelligence (AI)-based query system;
evaluate the response with respect to the user query using multiple AI-based scoring models to obtain multiple evaluation results;
in response to determining that the multiple evaluation results are inconsistent, evaluate the response with respect to the user query using a reference large language model (LLM) to provide a reference evaluation result;
in response to determining that the reference evaluation result is decisive, classify, based on the reference evaluation result, the dataset to a data category of one or more data categories; and
fine-tune the AI-based query system based on a group of datasets in the data category.

18. The non-transitory computer-readable medium of claim 17, further comprising processor-executable instructions configured to cause one or more processors to:
accesses multiple intermediate datasets generated by the AI-based query system during a process of generating the response with respect to the user query, the multiple intermediate datasets comprising analytics data of the user query, multiple search results, a ranking of the search results for response generation, and semantic analytics data of the response; and
evaluate the response by evaluating the multiple intermediate datasets using the multiple AI-based scoring models to obtain the multiple evaluation results.

19. The non-transitory computer-readable medium of claim 17, further comprising processor-executable instructions configured to cause one or more processors to:
in response to determining that the multiple evaluation results are consistent, classify the response and the corresponding user query based on the multiple evaluation results.

20. The non-transitory computer-readable medium of claim 17, further comprising processor-executable instructions configured to cause one or more processors to:
retrain one or more of the multiple AI-based scoring models by using the group of datasets in the data category.
